(19) United States
(12) Patent Application Publication
(10) Pub. No.: US 2017/0140237 A1
(43) Pub. Date: May 18, 2017

(54) Methods For Vehicle Identification And Specification Recall With Localization Optimization For License Plate Recognition

(71) Applicant: Hunter Engineering Company, St. Louis, MO (US)

(72) Inventors: David A. Voeller, St. Louis, MO (US); Daniel G. Eberhart, Bethalto, IL (US); Timothy A. Strege, Sunset Hills, MO (US); Nicholas J. Colarelli, III, Frontenac, MO (US)

(21) Appl. No.: 15/347,526

(22) Filed: Nov. 9, 2016

Related U.S. Application Data
(60) Provisional application No. 62/254,828, filed on Nov. 13, 2015.
(60) Provisional application No. 62/343,579, filed on May 31, 2016.

(51) Int. Cl. G06K 9/32; G06K 9/52; G06K 9/00

(52) U.S. Cl. CPC G06K 9/325; G06K 9/00442; G06K 9/52; G06K 9/3208; G06K 2009/4666

(57) ABSTRACT

A procedure for acquiring and utilizing vehicle license plate image data during a vehicle service or inspection process. Acquired license plate images are evaluated to identify visible license plate features including license plate characters and a license plate jurisdiction. The information is communicated to a data archive system which is configured to employ a set of jurisdiction localization rules to match a specific vehicle identification number to the license plate data. A compilation of the identified and matched data is communicated to a vehicle service system or inspection system, for utilization in a vehicle service procedure or inspection process.

### CROSS-REFERENCE TO RELATED APPLICATIONS

The present application is related to, and claims priority from, U.S. Provisional Patent Application Ser. No. 62/343,579 filed on May 31, 2016, and which is herein incorporated by reference. The present application is further related to, and claims priority from, U.S. Provisional Application Ser. No. 62/254,828 filed on Nov. 13, 2015, and which is herein incorporated by reference.

### STATEMENT REGARDING FEDERALLY SPONSORED RESEARCH

Not Applicable.

### BACKGROUND OF THE INVENTION

The present application is related to a method for vehicle identification and specification recall, and in particular, to a method for recalling a vehicle identification number (VIN) and vehicle identifying data based on a recognition of vehicle license plate data and jurisdiction identification, and the subsequent use of the VIN and vehicle identifying data to specifically identify the vehicle make, model, year, and factory options in order to recall vehicle-specific specifications and configuration data from a database.

Vehicle license plate recognition (LPR) image-processing technology is commonly utilized to capture identifying information from an image of a vehicle license plate. The technology is often used in a variety of security and traffic control or monitoring applications. A typical LPR system includes at least one imaging sensor for acquiring images of a vehicle, an image processing system for evaluating the acquired images to identify visible license plates, and a character recognition algorithm to extract relevant alpha-numerical data from the identified license plate image. The LPR system may further include an illumination system for use when ambient light is insufficient to illuminate the vehicle and license plate surfaces, and a network connection for exchanging data with one or more remote systems. The image processing system may be implemented as a hardware or software component associated with the imaging sensor, or may function as an independent processing system in communication with the imaging sensor.

In an automotive service environment, LPR may be utilized to assist a service center in identifying a customer or vehicle during an initial check-in or inspection. For example, as a customer drives a vehicle into a service lane to drop off the vehicle for service, an LPR system may capture the vehicle license plate data automatically, and convey identifying information to a service lane attendant station, enabling a vehicle service advisor to recall customer data quickly and efficiently.

In the event an LPR system is unable to adequately resolve the vehicle license plate data, incorrectly identifies one or more characters in the license plate image, or fails to identify the correct jurisdiction for the license plate data, the automated process for recalling customer data can break down, failing to recall any relevant information from the associated systems, or recalling incorrect information which is not associated with the specific vehicle or customer present at the service center. If the LPR system fails to recall any relevant information, the service advisor or technician can quickly recognize the situation, and obtain the missing information by other means. If however, the LPR system recalls incorrect information which is not associated with the specific vehicle or customer present, the error may be overlooked, leading to a cascade of problems ranging from incorrect vehicle identification, incorrect customer identification, recall of incorrect vehicle specifications, failure to identify relevant vehicle service history or outstanding manufacturer recall programs, etc.

Accordingly, it would be beneficial to improve an LPR system to improve the accuracy rate for the identification of vehicle license plate data, jurisdiction identification, and the recall of relevant information. Additional advantages may be realized by providing additional procedures to automate further steps in a vehicle service or inspection procedure based on the accurately recalled relevant vehicle information.

### BRIEF SUMMARY OF THE INVENTION

Briefly stated, the present disclosure sets forth a procedure for acquiring and utilizing vehicle license plate data during a vehicle service or inspection process. Initially, a vehicle enters into the detection region for an imaging sensor associated with a LPR system, triggering the acquisition of one or more images of the vehicle. The images are communicated to the LPR system, and evaluated to identify visible license plate features. The LPR system processes the identified license plate features to generate a packet of information which includes license plate characters and a license plate jurisdiction, such as a state, government branch, or country. The packet of information is communicated to a data archive system containing records associating specific vehicle identification numbers (VIN)s and other vehicle identifying features with license plate data, which returns a specific VIN and/or other vehicle identifying features corresponding to the license plate data contained in the communicated packet if a match is found within the stored records. A compilation of the identified and retrieved data, which may include the original image data, identified license plate characters, and a returned VIN and/or vehicle identifying feature data, is then communicated to a vehicle service system or inspection system, where it may be utilized in a vehicle service procedure or inspection process, such as by incorporation into an inspection report or record, or by subsequent evaluation of the returned data as an index to retrieve customer-specific records from an associated customer record database or vehicle-specific data from an associated vehicle record database.

In a further embodiment of the present disclosure, one or more additional imaging sensors are associated with the LPR system, and are configured to enable acquisition of images of both the front and rear license plate locations on a vehicle passing through the detection regions associated with the imaging sensors. The images from each imaging sensor are communicated to the LPR system, and evaluated to identify visible features for both front and rear license plates on the vehicle, if present. When both front and rear license plate features are identified, the LPR system evaluates the identified features with a front to rear cross-checking procedure to verify redundant information and to ensure the accuracy of the feature evaluation and associated optical character recognition. If the front to rear cross-checking procedure fails to confirm that identical features were found on both the front and rear license plates, the LPR system provides a suitable warning to an operator that the correct license plate information may not have been acquired for the specific vehicle. Optionally, the LPR system may provide the operator with an opportunity to review the identified front and rear license plate features, and to manually select which plate features to utilize for further processing.

In a further embodiment of the present disclosure, the LPR system is provided with a reference procedure for selecting, filtering, or ranking of license plate jurisdictional information. Acquired vehicle images are communicated to the LPR system, and evaluated to identify visible license plate features such as alpha-numeric characters, symbols, and colors. An evaluation of the visible license plate features determines if the alpha-numeric characters conform to rules or templates associated with license plate configurations for one or more jurisdictions. If required, jurisdictional-specific character substitution rules are applied. If the LPR system is unable to identify a specific jurisdiction from the visible license plate features, the LPR system is configured to utilize the reference procedure to establish a default jurisdiction, a ranked set of potential jurisdictions, or a set of excluded jurisdictions for inclusion in the packet of information communicated to the data archive system containing records associating specific vehicle identification numbers (VIN)s and other vehicle identifying features with license plate data. In response, the data archive system utilizes the communicated jurisdictional data to narrow the search for a specific license plate and corresponding VIN contained within the stored records by either focusing the search to only license plates within a default jurisdiction, to license plates contained in potential jurisdictions in a ranked order, or by eliminating any license plate records associated with each excluded jurisdiction from the search results.

In yet another embodiment, the LPR system is provided with a reference table for ranking license plate jurisdictional information based on the geographic proximity of potential jurisdictions to the geographic location of the vehicle service or inspection lane in which the LPR system is installed.

In an alternative embodiment, the LPR system is provided with a reference table for ranking license plate jurisdictional information based on the frequency with which license plates from different jurisdictions are observed at the geographic location of the vehicle service or inspection lane in which the LPR system is installed. This reference table may be static or dynamic, varying in accordance with changes in the observed frequency over a period of time.

In a further alternative embodiment, the LPR system is provided with a method for selecting a subset of license plate jurisdiction from a set of possible jurisdiction by filtering the set to exclude jurisdictions for which the identified alpha-numeric characters of the license plate do not conform to jurisdiction-specific acceptable sequences or templates.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an illustration of a vehicle moving through a detection region for a camera associated with a license plate recognition system;

FIG. 2 is a flow chart illustrating a procedure of the present disclosure for utilizing license plate data to recall vehicle identifying data, customer records, and/or vehicle specifications;

FIG. 3 is an illustration of the various system components for an exemplary vehicle identification system of the present disclosure associated with a vehicle service or inspection system;

FIG. 4 is an illustration of a vehicle moving through the detection region for a set of front and rear imaging sensors associated with a license plate recognition system;

FIG. 5 is a flow chart illustrating a procedure of the present disclosure for selecting a jurisdiction to associate with license plate data when none is identified from the acquired images;

FIG. 6 is an illustration of various system components for an exemplary dedicated vehicle identification system of the present disclosure; and

FIG. 7 is a flow chart similar to FIG. 2, illustrating an alternate procedure of the present disclosure for utilizing license plate data to recall vehicle identifying data, customer records, and/or vehicle specifications.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

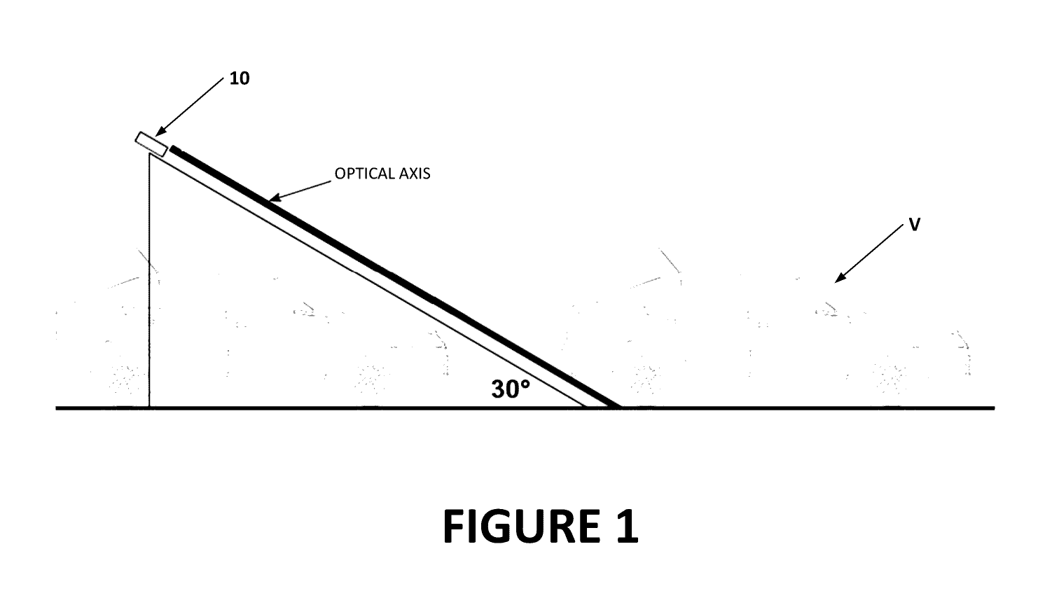

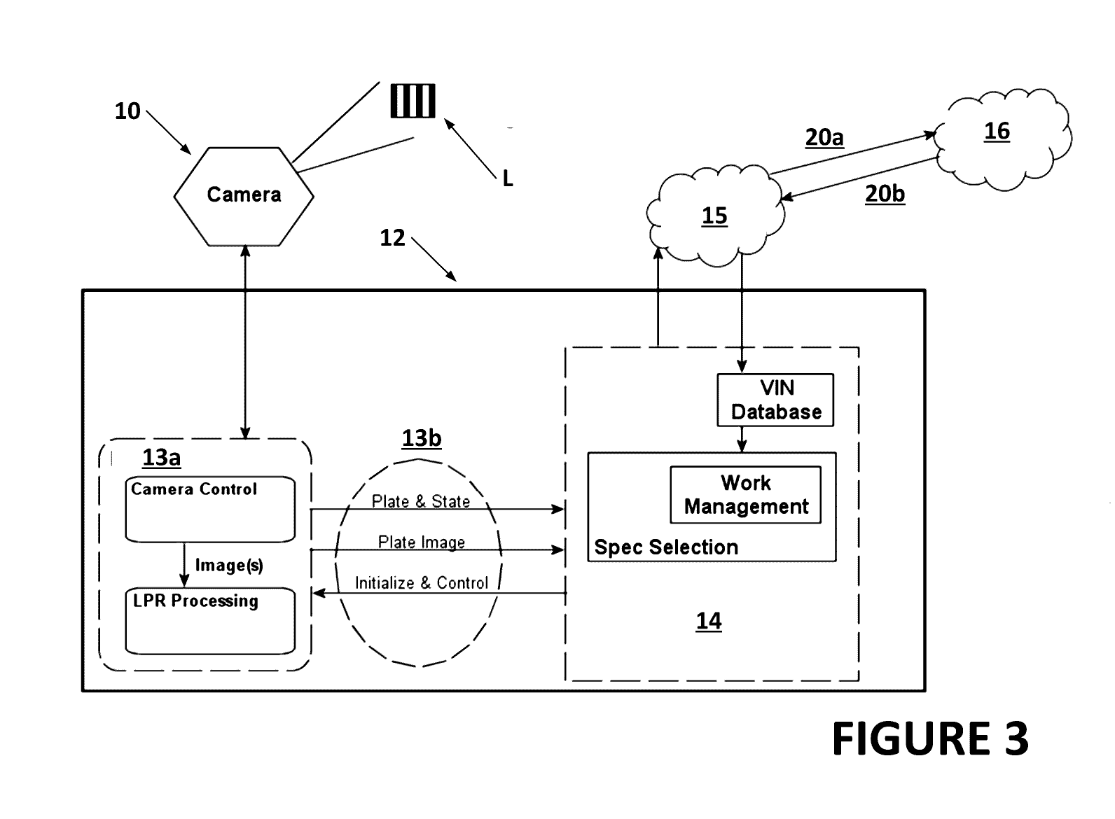

Turning to the figures, and to FIGS. 1-3 in particular, a process of the present disclosure for acquiring and utilizing vehicle license plate data during a vehicle service or inspection process begins with a vehicle V entering into a detection region for one or more imaging sensors or cameras 10 associated with a License Plate Recognition (LPR) system 12 in a vehicle service bay or inspection lane, triggering the acquisition of one or more images of the vehicle (Box 100). Detection of a vehicle V within the detection region may be by any suitable means, for example, such as shown in co-pending U.S. patent application Ser. No. 15/190,008, which is herein incorporated by reference. Images acquired by the sensors or cameras 10 may encompass a full view of the vehicle V and surrounding surfaces, or may be limited to a specific portion of the vehicle V, such as a front or rear surface on which a license plate may be positioned. The acquired images are communicated from each imaging sensor or camera 10 to the LPR system 12, and evaluated, such as by a processor configured with software instructions, to identify visible license plate features contained within the images (Box 110). It will be recognized that the LPR system 12 may be either a dedicated system consisting of the one or more cameras or imaging sensor(s) 10, a processor, and suitable image processing software, or it may simply consist of software programs and instructions such as a dynamic link library (DLL) 13a or component object module (COM) 13b, residing in an electronic memory or processor associated with a general purpose computer or other vehicle service/inspection system 14. The specific implementation of the LPR system 12 is not critical, provided that it is capable of acquiring or receiving images containing license plate features, and of generating the required output.

The LPR system 12 processes the identified license plate features to generate a packet of information 20a which includes representations of identified license plate alpha-numeric characters, symbols, and if possible, an identified license plate jurisdiction, such as a state, government branch, or country. The packet of information 20a is communicated (Box 120) via a communication link, such as the internet 15, either directly by the LPR system 12, or via a vehicle service or inspection system 14, to a data archive system 16 containing records associating specific vehicle identification numbers (VIN)s and other vehicle identifying features with license plate data. The data archive system 16 checks for a license plate match (Box 125) within the stored records and, if a match is found (Box 130), returns a responsive data packet 20b containing a specific VIN and any available vehicle identifying features. If no match is found, an appropriate no-match status response is provided (Box 135).

A compilation of the identified and retrieved data, which may include the original image data, identified license plate characters and symbols, and a returned VIN, as well as any available vehicle identifying data such as, but not limited to, vehicle make, model and sub-model names, model year, drive configuration, vehicle dimensions, and OEM tire fitment information, is then communicated to a vehicle service system or inspection system 14 (if not received directly thereby), where it may be utilized in a vehicle service procedure or inspection process (Box 140), either by incorporation into an inspection report or record (Box 170), or by subsequent evaluation of the returned VIN as an index to retrieve customer-specific data from an associated customer record database (Box 150) or vehicle-specific data from an associated vehicle record database (Box 160).

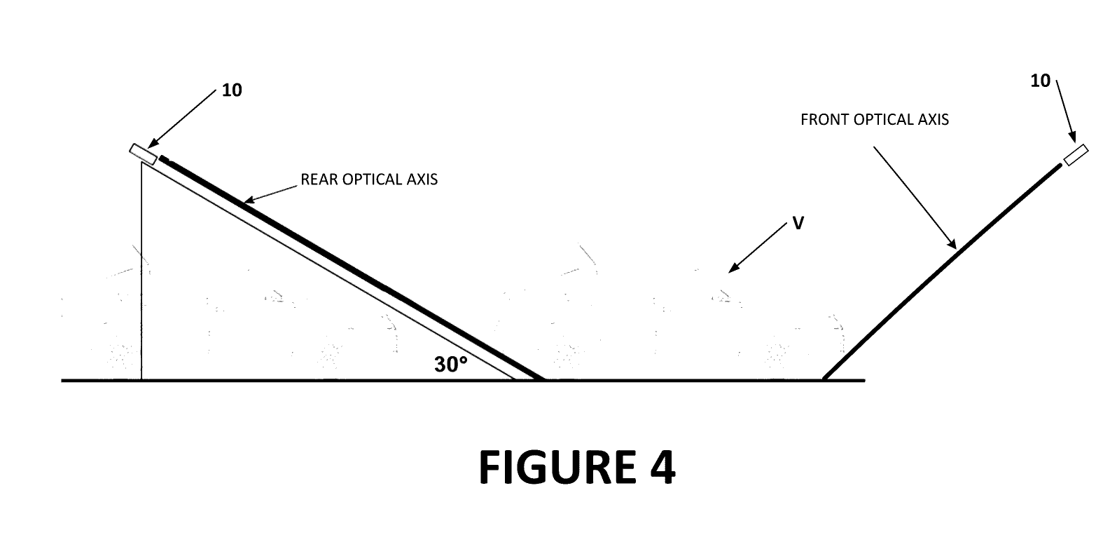

In a further embodiment of the present disclosure, illustrated in FIG. 4, one or more additional imaging sensors or cameras 10 are associated with the LPR system. Each camera 10 is configured to enable acquisition of images along a corresponding optical axis, including at least the front and rear license plate locations on a vehicle V passing through the detection region associated with the imaging sensors or cameras 10. The images from each imaging sensor or camera 10 are communicated to the LPR system 12, and evaluated to identify visible features for both front and rear license plates on the vehicle V, if each are present. When both front and rear license plate features are identified, the LPR system 12 further evaluates the identified features using a cross-checking or comparison procedure to verify redundant information from each observed license plate on a vehicle V, and to ensure the accuracy of the feature evaluation and associated optical character recognition. If the cross-checking or comparison procedure confirms observation of identical features on both the front and rear license plates of the vehicle V, the LPR system 12 verifies the identified features for use in a vehicle identification number lookup. If, however, the cross-checking or comparison procedure fails to confirm a finding of identical features on both the front and rear license plates, the LPR system 12 provides a suitable warning to an operator that the correct license plate information may not have been acquired for the vehicle V. Optionally, the LPR system 12 may provide the operator with an opportunity to review the identified front and rear license plate features, and to manually select which license plate features to utilize for further processing and vehicle identification number lookup.

Alternatively, two or more cameras 10 are configured to each enable acquisition of images of a common license plate location on a vehicle V passing through the detection region associated with the imaging sensors or cameras 10. The two or more cameras 10 may be disposed at different distances to the detection region, or aligned along different optical axis. The images from each imaging sensor or camera 10 are communicated to the LPR system 12, and evaluated to identify visible features for the license plate on the vehicle V. When the license plate features are identified, the LPR system 12 further evaluates the identified features using a cross-checking or comparison procedure to verify redundant information from each image, and to ensure the accuracy of the feature evaluation and associated optical character recognition. If the cross-checking or comparison procedure confirms observation of identical features on each license plate image, the LPR system 12 verifies the identified features for use in a vehicle identification number lookup. If, however, the cross-checking or comparison procedure fails to confirm a finding of identical features on each license plate image, such as due to excessive glare or shadow, the LPR system 12 provides a suitable warning to an operator that the correct license plate information may not have been acquired for the vehicle V. Optionally, the LPR system 12 may provide the operator with an opportunity to review the identified license plate images, and to manually select which license plate image to utilize for further processing and vehicle identification number lookup.

In a further embodiment of the present disclosure, each imaging sensor or camera 10 associated with the LPR system 12 is configured to acquire a sequence of images of a vehicle V, or portion thereof, passing through the associated detection region. The sequence of images are communicated to the LPR system 12, and are individually evaluated to identify visible features of a license plate if present. When license plate features are identified in two or more of the images, the LPR system 12 is configured to either select a “best” image for further evaluation (i.e., one in which the identified license plate features are most clearly visible, or which conform most closely to predetermined standards for size, contrast, color, viewing angle, etc.), or to implement a comparison procedure to verify redundant information identified on the observed license plate through the sequence of images. Redundant information verifies the accuracy of the feature evaluation and associated optical character recognition carried out by the LPR system 12. If the verification procedure confirms an observation of identical features on multiple images of the license plate, the LPR system 12 selects the identified features for use in a vehicle identification number lookup. If, however, the verification procedure fails to confirm that identical features were found in multiple images of the license plate, the LPR system 12 provides a suitable warning to an operator that the correct license plate information may not have been acquired for the vehicle V. Optionally, the LPR system may provide the operator with an opportunity to review the identified license plate features, and to manually select which license plate features to utilize for further processing and vehicle identification number lookup.

One of the inherent difficulties with automated license plate recognition is the identification of a jurisdiction associated with the license plate, such as a state, country, county, or government entity. A primary sequence of alpha-numeric characters and symbols on a license plate may be duplicated across multiple jurisdictions. Identification of the specific jurisdiction associated with an observed sequence of alpha-numeric characters and symbols is often required to be made by interpreting small abbreviations located at the periphery of the license plate, or the observed combination of character fonts, colors, contrast, and background images. It is not uncommon for the peripheral abbreviations to be hidden or partially obscured by surrounding license plate brackets, frames, or holders which secure the license plate to the vehicle V, or to be rendered illegible in the acquired images due to inadequate illumination, low contrast, off-axis viewing, blur caused by vehicle motion, or low image resolution.

In a further embodiment of the present disclosure, the LPR system 12 is provided with a procedure for selecting a jurisdictional designation to associate with the primary sequence of alpha-numeric characters identified from a license plate image from which no specific jurisdictional data can be identified, and to apply jurisdiction-specific and/or error-correcting character substitution rules to the sequence of primary alpha-numeric characters once a specific jurisdiction is selected.

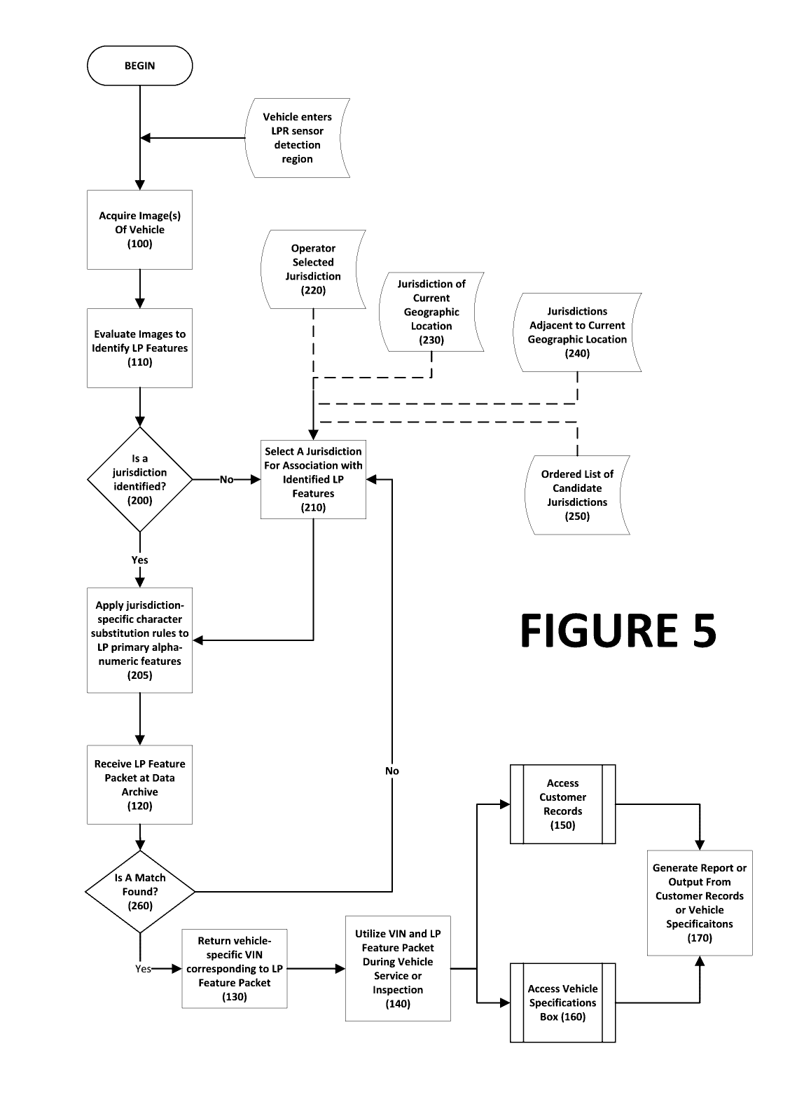

As seen in FIG. 5, vehicle images are acquired (Box 100) and communicated to the LPR system 12 for evaluation, to identify visible license plate features such as alpha-numeric characters, symbols, and colors (Box 110). If the LPR system 12 is able to identify a specific jurisdiction (Box 200) from the visible license plate features, the primary sequence of alpha-numeric characters is evaluated (Box 205) to determine if any character substitutions are required in accordance with either jurisdiction-specific rules and/or error-correcting rules for evaluating commonly miss-identified characters. For example, some jurisdictions require that all letter “i” characters be interpreted as a numeral “1”, and that all letter “o” characters be interpreted as a numeral “0”. Similarly, some character fonts utilized by license plates render the distinctions between characters such as “O” and “Q” and “B” and “8” difficult for optical character recognition software to identify. Providing a set of error-correcting rules enables substitution for characters which are known to be difficult to distinguish.

For situations where the LPR system 12 is unable to identify a specific jurisdiction from the visible license plate features (Box 200), the LPR system 12 is configured to select a designated jurisdiction to associate with the identified license plate features (Box 210). Several different options are available for selecting the designated jurisdiction, and the specific option chosen or implemented in the LPR system 12 may be based on operator choice or a system setup configuration. For example, an operator can manually designate a chosen jurisdiction (Box 220), or a default jurisdiction may be designated (Box 230) corresponding to the current geographical location of the LPR system (i.e. the state in which the automotive service shop or inspection station is located). Alternatively, an ordered set of jurisdictions, for example, based on a geographic proximity to the geographic location of the LPR system (Box 240) or other criteria (Box 250) such as frequency of occurrence, may be provided. The ordered sets (Box 240, 250) may optionally be filtered, prioritized, or ranked to ensure that a primary jurisdiction is evaluated first, and may be static or dynamic, varying in accordance with changes in the priority or ranking.

In one embodiment, the primary sequence of alpha-numeric characters and symbols identified from the license plate image is evaluated against a set of jurisdiction-specific character arrangement rules, templates, or filters and/or error-correcting rules to prevent the selection of any designated jurisdiction (Box 210) for which the arrangement of the identified primary sequence of alpha-numeric characters represents an invalid license plate designation.

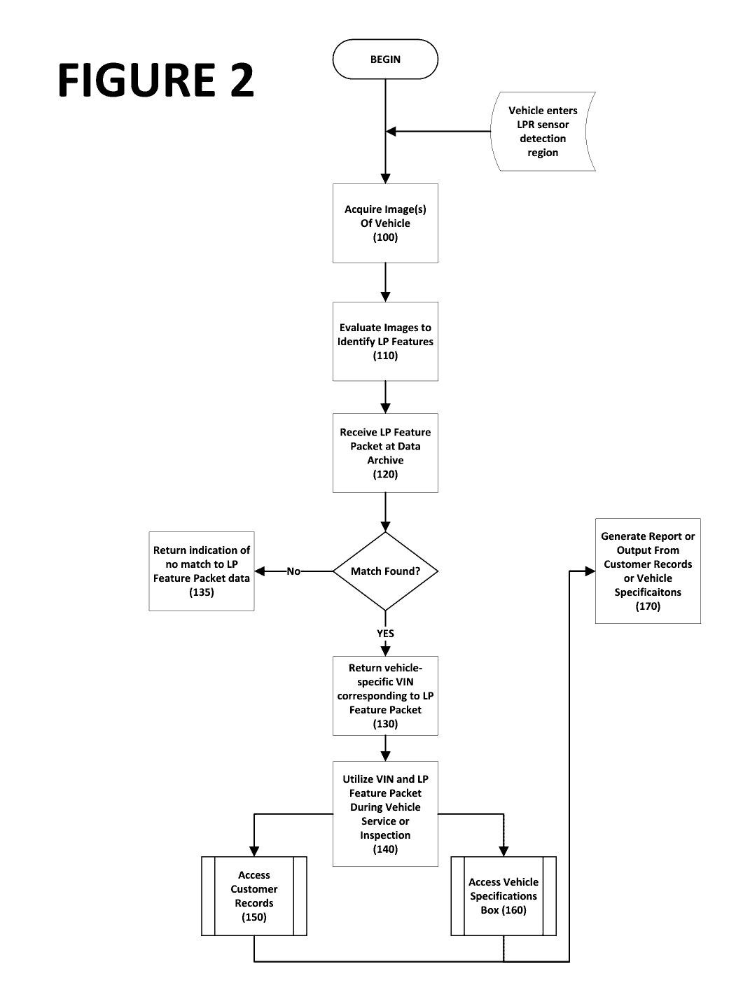

At least one selected jurisdiction is then combined with the identified license plate features and communicated to the data archive (120) as previously described to attempt to identify a corresponding vehicle identification number (VIN) associated with license plate data. The data archive system utilizes the communicated jurisdictional data to narrow the search for a specific license plate matching the identified alpha-numeric features and symbols within the specifically identified jurisdictions (Box 260). If a match is found, the data archive system returns a corresponding VIN contained within the stored records (Box 130), and the process continues as shown in FIG. 2. If a match is not found, the query may be repeated using the same identified alpha-numeric features and a different jurisdiction (Box 210), such as may be sequentially selected from an identified set of potential jurisdictions.

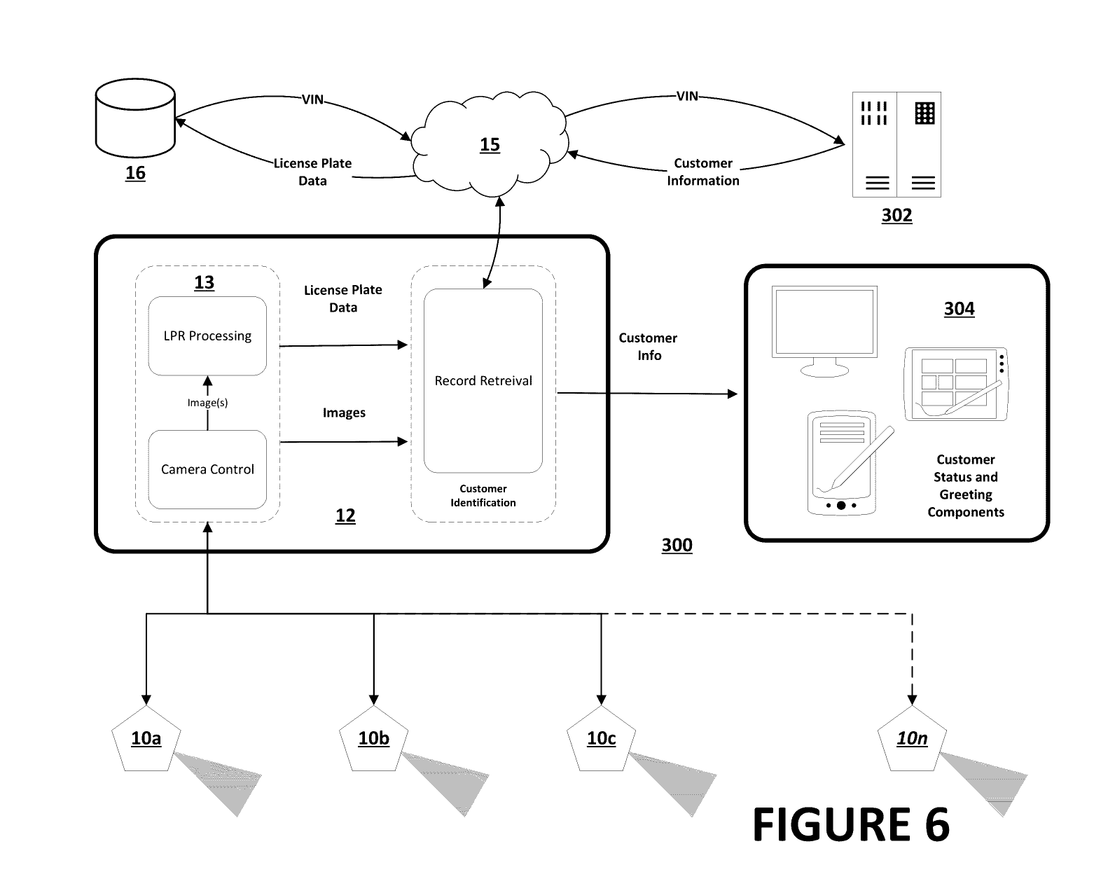

While the aforementioned embodiments have been presented in the context of acquiring and utilizing vehicle license plate data during a vehicle service or inspection process, and hence have been associated with a vehicle service or inspection system, a further embodiment of the present disclosure illustrated in FIG. 6 is directed primarily towards vehicle and customer identification. Automotive dealers and service shops often have multiple service or vehicle reception lanes for receiving the vehicles V of arriving customers. By utilizing an automated vehicle identification system 300 such as shown in FIG. 6, a customer's vehicle V can be identified upon initial entry into one of multiple service or reception lanes following acquisition of an image of the vehicle's license plate for image processing and VIN retrieval as previously described. Multiple cameras 10 are linked to the vehicle identification system 300 by any suitable communication link, such as Ethernet cables, to provide coverage for each service or reception lane, and/or may be utilized to track movement of a vehicle V through various zones in a vehicle service facility, such as reception, alignment bay, tire service area, car wash, and customer pick-up areas. By providing the vehicle identification system 300 with access to customer records stored in a dealer management system (DMS) 302 or other accessible database, the system 300 can be configured to utilize retrieved VIN data and vehicle identifying data to recall corresponding vehicle owner or customer information from the DMS for presentation in the form of an automated customer greeting upon arrival at the facility, or status updates as the vehicle V progresses through various services. This information may be presented on any suitable display device 304, such as a monitor visible to the customer upon entry into the service or reception lane, on a customer's accessible mobile device via text, e-mail, or dedicated software application, or as status updates in a customer lounge or waiting area. Technicians and/or service managers responsible for the vehicle V may additionally receive similar information, enabling personalized customer experiences and improved work-flow tracking within an automotive service facility.

It is recognized and understood that information for matching vehicle license plate data with specific VIN data and vehicle identifying features stored in a data archive may not be complete or fully accurate. For example, if the records are not updated regularly, a record linking a particular license plate to a particular VIN may not accurately reflect a recent vehicle sale transaction wherein the license plate was transferred to a new vehicle. If the license plate data is entered into the system, the VIN associated with the sold vehicle will be recalled, leading to potential downstream errors or incorrect actions by the vehicle service system or service show which relies upon the recalled information.

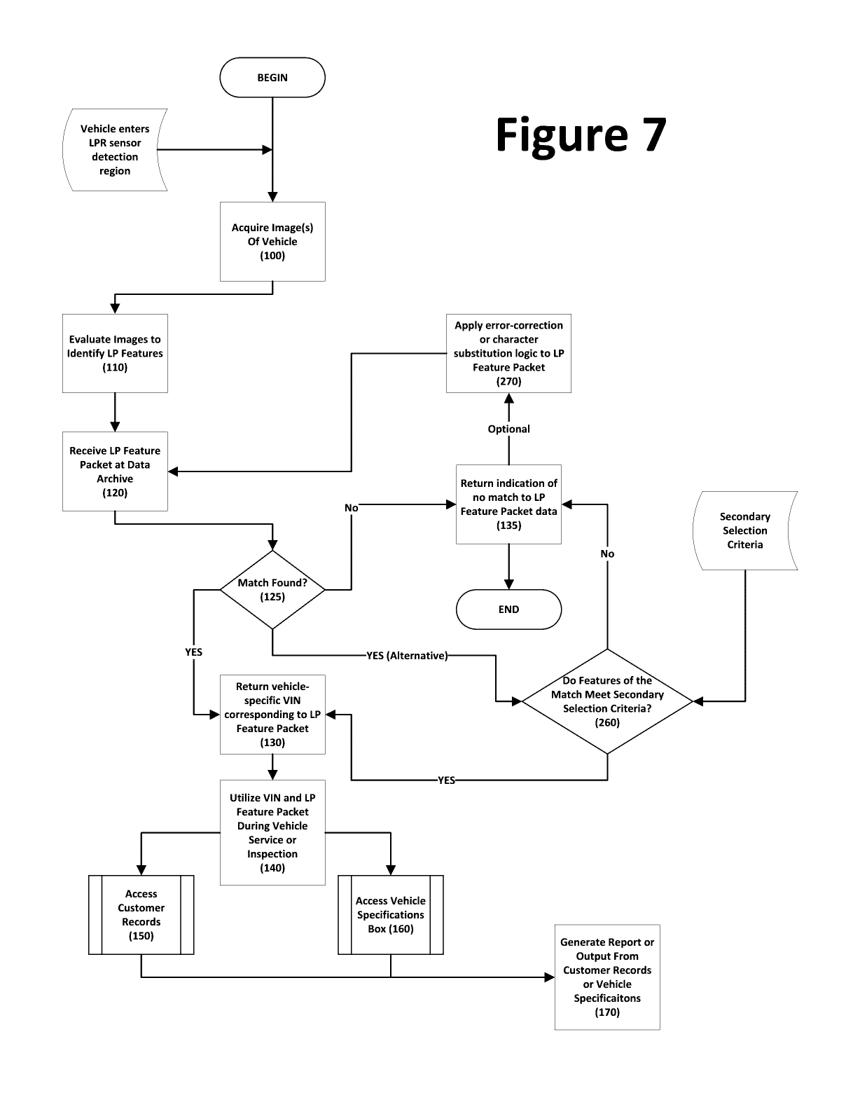

In a further method of the present disclosure, the previously described method shown in FIG. 2 and described above is modified as shown in FIG. 7 to provide options for refining matches between the license plate data contained in a data packet 20a and records stored in the data archive (Box 120) containing a specific VIN and any available vehicle identifying features. In a first option, shown at (Box 260), records stored in the data archive which are found to match (Box 125) the license plate information in a data packet 20a are reviewed (Box 260) against one or more secondary selection criteria to increase the likelihood of having found a preferred match. Secondary selection criteria may include filters for particular vehicle makes or models, such that results are only confirmed as a match and returned (Box 130) if the license plate data is matched to a VIN associated with a particular vehicle make or model. This is useful for applications of the present disclosure in vehicle dealer service centers, wherein the vehicles undergoing inspection or service are disproportionally represented by a small number of vehicle makes, such as Ford vehicles, or models, such as light and medium duty trucks.

In the event a match between the license plate information in the data packet 20a and a VIN is found (Box 125), but fails to meet the secondary selection criteria (Box 260), the process may return an indication that no conforming match was found (Box 135), and terminate the procedure.

Optionally, if no conforming match is found (Box 135), either in response to the initial query (Box 125) or to the secondary selection criteria (Box 260), the procedure may apply error-correction or character substitution logic to the character sequence representing the license plate (Box 270), and repeat the process to see if a suitable match can be made (Box 125). This cycle may be repeated until all available error-correction or character substitution logic options have been exhausted, or may be limited to a predetermined number of cycles before returning an indication of no match found (Box 135).

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A method for capturing and utilizing vehicle license plate data during a vehicle service or inspection process, comprising:
acquiring at least one image of a vehicle upon entry of the vehicle into a detection region of at least one imaging sensor coupled to a license plate recognition system;
communicating said acquired at least one image from said at least one imaging sensor to said license plate recognition system;
evaluating said acquired at least one image to identify visible license plate features including at least one alpha-numeric character;
utilizing said identified license plate features to retrieve, from a data repository, vehicle identifying data associated with said identified license plate features; and
utilizing said vehicle identifying data to retrieve, from a record repository, at least one of a customer record, a vehicle record, or a vehicle specification.

2. The method of claim 1 further including the step of generating an output containing at least said retrieved vehicle identifying data, and at least one of a portion of said retrieved customer record or said retrieved vehicle specification.

3. The method of claim 1 wherein said visible license plate features include a jurisdiction identifier.

4. The method of claim 1 wherein said retrieved vehicle identifying data includes a vehicle identification number associated with said identified license plate features.

5. The method of claim 1 further including the step of communicating said identified license plate features to a vehicle service or inspection system, said vehicle service or inspection system retrieving said vehicle identifying data, and retrieving said at least one customer record, vehicle record, or vehicle specification.

6. The method of claim 1 wherein acquiring at least one image of said vehicle includes acquiring at least a first image of said vehicle from a first imaging sensor at a first location and acquiring at least a second image of said vehicle from a second imaging sensor at a second location; and
wherein said step of evaluating said acquired at least one image includes evaluating said acquired first image to identify visible license plate features including at least one alpha-numeric character, and evaluating said acquired second image to identify visible license plate features including at least one alpha-numeric character.

7. The method of claim 6 further including the step of comparing said identified first and second license plate features for verification of said identified license plate features prior to utilizing said identified license plate features to retrieve said vehicle identifying data.

8. The method of claim 6 wherein said first location is in front of said vehicle, and said first image includes visible front license plate features, and
wherein said second location is behind said vehicle, and said second image includes visible rear license plate features.

9. The method of claim 6 wherein said first and second imaging sensors are at different distances from said detection region.

10. The method of claim 6 wherein said first and second imaging sensors are disposed at different orientations with respect to said detection region.

11. The method of claim 1 wherein said step of utilizing said identified license plate features includes parsing said at least one alpha-numeric character within said set of license plate features with a character substitution filter to selectively replace at least one alpha-numeric character within said set of license plate features in response a defined set of rules prior to retrieving said vehicle identifying data.

12. The method of claim 1 wherein said retrieved vehicle identifying data includes original equipment tire fitment information.

13. The method of claim 1 wherein said retrieved vehicle identifying data includes at least one vehicle parameter identifying a vehicle make, a vehicle model name, a vehicle sub-model name, a vehicle model year, or a vehicle drive configuration.

14. A vehicle service or inspection system configured to utilizing vehicle license plate data during a vehicle service or inspection process, comprising:
at least one imaging sensor or camera configured to acquire at least one image of a vehicle upon entry of the vehicle into an associated detection region;
a license plate recognition system operatively coupled to said at least one imaging sensor or camera to receive said acquired at least one image, said license plate recognition system configured to evaluate said acquired at least one image to identify visible license plate features including at least one alpha-numeric character;
wherein said license plate recognition system is further configured to convey said identified license plate features to a vehicle service or inspection system;
wherein said vehicle service or inspection system is configured to utilize said identified license plate features to retrieve, from a data repository, vehicle identifying data associated with said identified license plate features; and
wherein said vehicle service or inspection system is further configured to utilize said vehicle identifying data to retrieve, from a record repository, at least one of a customer record, a vehicle record, or a vehicle specification.

15. The system of claim 14 wherein said vehicle service or inspection system evaluates said retrieved vehicle identifying data associated with said license plate features against a set of secondary selection criteria, and wherein said vehicle service or inspection system is configured to retrieve said at least one customer record or vehicle specification from said record repository only in response to said retrieved vehicle identifying data meeting said secondary selection criteria.

16. A method for selectively filtering vehicle identifying data stored in a database and which is cross-referenced to vehicle license plate data containing at least one alpha-numeric character, comprising:
evaluating an image of a vehicle to identify a character set including each alpha-numeric character associated with a license plate on said vehicle;
generating a query to said database to retrieve vehicle identifying data corresponding to said vehicle, said query including said character set, and an associated jurisdictional designation which was not obtained from said evaluation of said image; and
receiving said vehicle identifying data in response to a match within said database of said character set in combination with said associated jurisdictional designation.

17. The method of claim 16 wherein said associated jurisdictional designation is selected based on a geographic location.

18. The method of claim 16 further including receiving a no-match warning in response to a failure of said query to match said character set and said associated jurisdictional designation with vehicle identifying data stored in said database.

19. The method of claim 18 wherein said associated jurisdictional designation is selected from an ordered set of jurisdictional designations;
responsive to a receipt of a no-match warning from a query, generating a new query to said database to retrieve vehicle identifying data corresponding to said vehicle, said new query including said character set and a next-sequentially selected associated jurisdictional designation selected from said ordered set of associated jurisdictional designations; and
repeating said step of generating a new query for each no-match warning received, until either said vehicle identifying data is received or each associated jurisdictional designation in said ordered set of associated jurisdictional designations has been utilized in a new query.

20. The method of claim 18 wherein responsive to a receipt of a no-match warning from a query, parsing said character set with a character substitution filter to selectively replace at least one alpha-numeric character within said character set in response a defined set of rules;
generating a new query to said database to retrieve vehicle identifying data corresponding to said vehicle, said new query including said parsed character set and said associated jurisdictional designation; and
repeating said step of generating a new query for each no-match warning received, until either said vehicle identifying data is received or each possible character substitution within said defined set of rules has been utilized in a new query.

21. A method for vehicle identification using vehicle license plate data, comprising:
receiving, a set of license plate features associated with a vehicle, said set of license plate features including at least one alpha-numeric character;
selecting, from a set of possible jurisdictions, a jurisdiction for association with said set of license plate features;
utilizing said identified license plate features and said associated jurisdiction to locate within a data repository, vehicle identifying data associated with said identified license plate features;
responsive to a failure to locate said vehicle identifying data within said data repository, repeating said steps of selecting and utilizing, by selecting a previously unselected jurisdiction from said set of possible jurisdictions; and
providing an output, said output being either an indication of failure or an indication of said vehicle identifying data, wherein:
i. said indication of failure is provided in response to selection of each jurisdiction within said set of possible jurisdictions, together with a failure to locate said vehicle identifying data within said data repository, and
ii. said indication of said vehicle identifying data is provided in response to a successful location of said vehicle identifying data within said data repository.

22. The method of claim 21 wherein said set of possible jurisdictions is an ordered set.

23. The method of claim 21 wherein said step of utilizing includes parsing said at least one alpha-numeric character within said set of license plate features with a character substitution filter to selectively replace alpha-numeric characters within said set of license plate features in response a defined set of rules, said character substitution filter selected in accordance with said associated jurisdiction.

24. The method of claim 21 wherein said step of selecting includes evaluating said set of license plate features with a filter associated with at least one jurisdiction; and
excluding, from said set of possible jurisdictions, each jurisdiction for which said set of license plate features does not pass said associated filter.

25. A method for selectively filtering vehicle identifying data stored in a database and indexed by at least one alpha-numeric character and an associated jurisdiction, comprising:
evaluating an image of a vehicle to identify at least one alpha-numeric character associated with a license plate on said vehicle;
selecting a jurisdiction for association with said license plate;
parsing said at least one alpha-numeric character to apply a set of jurisdiction-specific rules in order to generate an output string of alpha-numeric characters associated with said license plate;
generating a query to said database to retrieve vehicle identifying data corresponding to said vehicle, said query including said output string and said selected jurisdiction; and
receiving said vehicle identifying data in response to a match within said database of said string of alpha-numeric characters and said selected jurisdiction.

26. The method of claim 25 wherein said associated jurisdiction is selected based on proximity to a geographic location.

27. The method of claim 25 further including receiving a no-match warning in response to a failure of said query to match said string and said selected jurisdiction with vehicle identifying data stored in said database.

28. The method of claim 27 wherein said jurisdiction is selected from a set of jurisdictional designations; and
responsive to a receipt of a no-match warning from said generated query, selecting a new jurisdiction from a set of jurisdictions for association with said license plate and repeating said steps of parsing and generating with said string and said new jurisdiction until either said vehicle identifying data is received or each jurisdiction within said set of jurisdictions has been utilized in a query with said string.

29. A method for selectively filtering vehicle identifying data stored in a database and which is cross-referenced to vehicle license plate data containing at least one alpha-numeric character, comprising:
evaluating an image of a vehicle to establish a representation of alpha-numeric characters and symbols associated with a license plate on said vehicle;
generating a query to said database to retrieve vehicle identifying data corresponding to said vehicle, said query including said representation, and at least one additional selection criteria; and
receiving said vehicle identifying data in response to a match within said database of said representation in combination with each selection additional criteria.

30. The method of claim 29 wherein said at least one additional selection criteria includes at least one jurisdictional designation.

31. The method of claim 29 wherein said at least one additional selection criteria is a vehicle make, a vehicle model, or a vehicle year.

32. The method of claim 29 further including receiving a no-match warning in response to a failure of said query to uniquely match said representation and each additional selection criteria with vehicle identifying data stored in said database.

33. The method of claim 32 wherein responsive to a receipt of a no-match warning from a query, altering said representation by applying error-correction and/or character-substitution logic to said alpha-numeric characters and symbols associated with said license plate generate a new query to said database to retrieve vehicle identifying data corresponding to said vehicle, said new query including said altered representation and said at least one additional selection criteria; and
repeating said steps of altering said representation and generating a new query for each no-match warning received, until either said vehicle identifying data is received or a new query limit is reached.
